(19) United States
(12) Patent Application Publication
(10) Pub. No.: US 2026/0064823 A1
(43) Pub. Date: Mar. 5, 2026

(54) DEVICE SECURITY ANALYZATION METHOD AND ELECTRONIC DEVICE

(71) Applicant: ASRock Industrial Computer Corporation, Taipei City (TW)

(72) Inventors: Chao-Wei Yu, Taipei City (TW); Chia-Ming Liu, Taipei City (TW)

(73) Assignee: ASRock Industrial Computer Corporation, Taipei City (TW)

(21) Appl. No.: 19/181,672

(22) Filed: Apr. 17, 2025

(30) Foreign Application Priority Data
Sep. 5, 2024 (TW) 113133577

(51) Int. Cl. G06F 21/44; G06F 21/73; G06F 21/85

(52) U.S. Cl. CPC G06F 21/44; G06F 21/73; G06F 21/85

(57) ABSTRACT

Provided are a device security analyzation method and an electronic device. The method includes the following. In response to an external device being connected to the electronic device, the external device is maintained in an isolation status, and it is determined whether the external device meets a de-isolation condition. If the external device does not meet the de-isolation condition, in a time period of the external device being in the isolation status, a security analyzation is performed on the external device through a sandbox analyzation module. Also, it is determined whether to switch the external device to a connection status according to an execution result of the security analyzation.

### CROSS-REFERENCE TO RELATED APPLICATION

This application claims the priority benefit of Taiwan application serial no. 113133577, filed on Sep. 5, 2024. The entirety of the above-mentioned patent application is hereby incorporated by reference herein and made a part of this specification.

### BACKGROUND

### Technical Field

The disclosure relates to an information security protection technology, and particularly relates to a device security analyzation method and an electronic device.

### Related Art

With the advancement of technology, the threats to information security are also increasing. In daily life, electronic devices of users (such as smartphones, personal computers, or servers) are usually connected to external devices to read data from external devices, store data to external devices, or execute extended functions through external devices. However, if the external device carries malicious programs with active propagation or infection capabilities, when the external device is connected to the electronic device, the electronic device may be implanted with malicious programs, thereby becoming a zombie host controlled by hackers or a target for hackers to steal secrets.

### SUMMARY

The disclosure provides a device security analyzation method and an electronic device, which can improve the above-mentioned problems and enhance the security of the electronic device when accessing external devices.

An embodiment of the disclosure provides a device security analyzation method for an electronic device, the electronic device runs with a sandbox analyzation module, and the device security analyzation method includes the following. In response to an external device being connected to the electronic device, the external device is maintained in an isolation status, and it is determined whether the external device meets a de-isolation condition. If the external device does not meet the de-isolation condition, in a time period of the external device being in the isolation status, a security analyzation is performed on the external device through the sandbox analyzation module. Also, it is determined whether to switch the external device to a connection status according to an execution result of the security analyzation.

An embodiment of the disclosure further provides an electronic device, which includes an interface circuit, a storage circuit, and a processor. The interface circuit is configured to connect to an external device. The storage circuit is configured to store a sandbox analyzation module. The processor is connected to the interface circuit and the storage circuit. The processor is configured to perform the following. In response to the external device being connected to the electronic device through the interface circuit, the external device is maintained in an isolation status, and it is determined whether the external device meets a de-isolation condition. If the external device does not meet the de-isolation condition, in a time period of the external device being in the isolation status, a security analyzation is performed on the external device through the sandbox analyzation module. Also, it is determined whether to switch the external device to a connection status according to an execution result of the security analyzation.

Based on the above, after the electronic device is connected to the external device, the external device is first be maintained in the isolation status. At the same time, the electronic device may determine whether the external device meets the de-isolation condition. If the external device does not meet the de-isolation condition, then in the time period of the external device being in the isolation status, the electronic device may execute the security analyzation on the external device through the sandbox analyzation module, and determine whether to switch the external device to the connection status according to the execution result of the security analyzation. Thereby, the security of the electronic device when accessing the external device can be effectively enhanced under the premise of minimizing the impact on the working performance of the electronic device.

### BRIEF DESCRIPTION OF THE DRAWINGS

FIG. 1 is a schematic diagram of a device security analyzation system according to an embodiment of the disclosure.

FIG. 2 is a schematic diagram of accessing an external device in a connection status according to an embodiment of the disclosure.

FIG. 3 is a schematic diagram of executing a security analyzation on the external device through a sandbox analyzation module in an isolation status according to an embodiment of the disclosure.

FIG. 4 is a flowchart of a device security analyzation method according to an embodiment of the disclosure.

### DESCRIPTION OF THE EMBODIMENTS

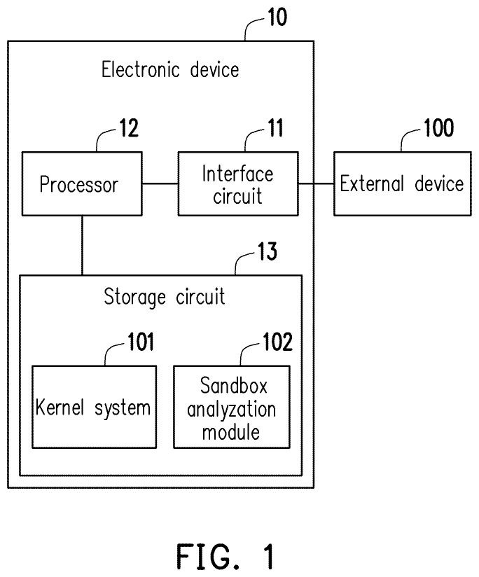

FIG. 1 is a schematic diagram of a device security analyzation system according to an embodiment of the disclosure. Referring to FIG. 1, the device security analyzation system may include an electronic device 10 and an external device 100. The electronic device 10 may be a smartphone, a tablet computer, a desktop computer, an industrial computer, a game console, a server, a wearable device (such as a head-mounted display, a watch, a wristband) or a computer device installed in a specific carrier (such as a vehicle, an aircraft, or a ship), and the type of the electronic device 10 is not limited thereto.

The external device 100 may also be a smartphone, a tablet computer, a desktop computer, an industrial computer, a game console, a server, a wearable device (such as a head-mounted display, a watch, a wristband) or a computer device or information storage device (such as a USB flash drive or an external hard drive) installed in a specific carrier (such as a vehicle, an aircraft, or a ship), and the type of the external device 100 is not limited thereto. In addition, the quantity of the external device 100 may be one or more, and the disclosure is not limited thereto.

The electronic device 10 may include an interface circuit 11, a processor 12, and a storage circuit 13. The interface circuit 11 is configured to connect to the external device 100. For example, the interface circuit 11 may connect the electronic device 10 to the external device 100 through a wired or wireless method. For example, the interface circuit 11 may support wireless communication standards such as WiFi, Bluetooth, Near-Field Communication (NFC), 3G, 4G, or 5G, and wired communication standards other such as Universal Serial Bus (USB), so as to communicate with the external device 100 (for example, to transmit signals between the electronic device 10 and the external device 100). Alternatively, the interface circuit 11 may also support other communication standards, and the disclosure is not limited thereto. In addition, the disclosure does not limit the quantity or type of the interface circuit 11.

The processor 12 is connected to the interface circuit 11 and the storage circuit 13. The processor 12 may include a Central Processing Unit (CPU), a Graphic Processing Unit (GPU), or other programmable general-purpose or special-purpose microprocessors, a Digital Signal Processor (DSP), a programmable controller, an Application Specific Integrated Circuit (ASIC), a Programmable Logic Device (PLD), or other similar devices, or a combination of the devices.

In an embodiment, the processor 12 may further include a processor specifically designed to assist in executing logical operations (such as neural network computations and/or image processing) such as a Vision Processing Unit (VPU), a Neural network Processing Unit (NPU), and/or a Tensor Processing Unit (TPU). However, the disclosure does not limit the quantity or type of the processor 12.

The storage circuit 13 is configured to store data. For example, the storage circuit 13 may include a volatile storage circuit and a non-volatile storage circuit. The volatile storage circuit is configured to store data in a volatile manner. For example, the volatile storage circuit may include a Random Access Memory (RAM) or similar volatile storage media. The non-volatile storage circuit is configured to store data in a non-volatile manner. For example, the non-volatile storage circuit may include a Read Only Memory (ROM), a Solid State Disk (SSD), a Hard disk drive (HDD), or similar non-volatile storage media. However, the disclosure does not limit the quantity or type of the storage circuit 13.

In an embodiment, the storage circuit 13 is configured to store a kernel system 101 and a sandbox analyzation module 102. The kernel system 101 is configured to control the overall operation of the electronic device 10. For example, the kernel system 101 may include an Operation System (OS) of the electronic device 10. In an embodiment, the processor 12 may run the kernel system 101 to control the overall operation of the electronic device 10.

In an embodiment, the sandbox analyzation module 102 may operate independently outside the kernel system 101. Specifically, the sandbox analyzation module 102 may be configured to execute a security analyzation on the external device 100 when the kernel system 101 cannot access the external device 100. In other words, in an embodiment, when the kernel system 101 cannot access the external device 100, the processor 12 may run the sandbox analyzation module 102 to execute the security analyzation on the external device 100 without affecting the operation of the kernel system 101.

In an embodiment, the electronic device 10 may further include various input/output devices such as a power management circuit, a mouse, a keyboard, a display, a speaker and/or a microphone, and the type of input/output interface is not limited thereto.

In an embodiment, the processor 12 may detect whether the external device 100 is connected to the electronic device 10 through the interface circuit 11. In an embodiment, if the external device 100 is connected to the interface circuit 11 through a wired connection method, then the processor 12 may determine whether the external device 100 is connected to the electronic device 10 by detecting a potential state of at least one electrical pin of the interface circuit 11. For example, when the potential state of the at least one electrical pin of the interface circuit 11 is a certain potential state (also referred to as a first potential state), the processor 12 may determine that the external device 100 is connected to the electronic device 10. However, when the potential state of the at least one electrical pin of the interface circuit 11 is another potential state (also referred to as a second potential state), the processor 12 may determine that the external device 100 is not connected to the electronic device 10. The first potential state may be different from the second potential state. For example, the first potential state may be logic high, and the second potential state may be logic low. However, the first potential state and the second potential state may be adjusted according to practical requirements, and the disclosure is not limited thereto.

In an embodiment, if the external device 100 is connected to the interface circuit 11 through a wireless connection method, then the processor 12 may determine whether the external device 100 is connected to the electronic device 10 through a flag reflecting a connection status of the external device 100 and the electronic device 10. For example, when the flag reflecting the connection status of the external device 100 and the electronic device 10 is in a certain bit state (also referred to as a first bit state), the processor 12 may determine that the external device 100 is connected to the electronic device 10. However, when the flag reflecting the connection status of the external device 100 and the electronic device 10 is in another bit state (also referred to as a second bit state), the processor 12 may determine that the external device 100 is not connected to the electronic device 10. The first bit state may be different from the second bit state. For example, the first bit state may be bit “1”, and the second bit state may be bit “0”. However, the first bit state and the second bit state may be adjusted according to practical requirements, and the disclosure is not limited thereto.

In an embodiment, in response to the external device 100 being connected to the electronic device 10 (as shown in FIG. 1), the processor 12 may automatically maintain the external device 100 in an isolation status. In an embodiment, the isolation status is also referred to as an unbind status. It should be noted that, in the isolation status, the kernel system 101 cannot access the external device 100. In an embodiment, in a time period of the external device 100 being in the isolation status, the processor 12 may prohibit the kernel system 101 from accessing the external device 100.

In an embodiment, in response to the external device 100 being connected to the electronic device 10 (as shown in FIG. 1), the processor 12 may further determine whether the external device 100 meets a de-isolation condition. In an embodiment, the de-isolation condition is also referred to as a bind condition.

In an embodiment, if the processor 12 determines that the external device 100 meets the de-isolation condition, the processor 12 may switch the external device 100 from the isolation status to the connection status. In an embodiment, the connection status is also referred to as a bind status. It should be noted that, in the connection status, the kernel system 101 can access the external device 100. In an embodiment, if the external device 100 is in the connection status, then the processor 12 may allow the kernel system 101 to access the external device 100. For example, if the external device 100 is in the connection status, then the kernel system 101 may read data from the external device 100, store data to the external device 100, and/or execute specific operational behaviors through the external device 100.

In an embodiment, after the external device 100 is connected to the electronic device 10, the processor 12 may obtain device identification information of the external device 100. For example, the device identification information may be configured to uniquely identify the external device 100. For example, the device identification information may include a device name, a device type, and/or other information that may be used to uniquely identify the external device 100.

In an embodiment, after obtaining the device identification information of the external device 100, the processor 12 may compare the device identification information with a device list. For example, the device list may be used to record device identification information of one or more external devices. The processor 12 may determine whether the external device 100 meets the de-isolation condition according to a comparison result.

In an embodiment, the processor 12 may adopt a whitelist filtering mechanism to determine whether the external device 100 meets the de-isolation condition. For example, in the whitelist filtering mechanism, if the comparison result reflects that the device identification information of the external device 100 is recorded in the device list, then the processor 12 may determine that the external device 100 meets the de-isolation condition. However, if the comparison result reflects that the device identification information of the external device 100 is not recorded in the device list, then the processor 12 may determine that the external device 100 does not meet the de-isolation condition.

In an embodiment, the processor 12 may also adopt a blacklist filtering mechanism to determine whether the external device 100 meets the de-isolation condition. For example, in the blacklist filtering mechanism, if the comparison result reflects that the device identification information of the external device 100 is recorded in the device list, then the processor 12 may determine that the external device 100 does not meet the de-isolation condition. However, if the comparison result reflects that the device identification information of the external device 100 is not recorded in the device list, then the processor 12 may determine that the external device 100 meets the de-isolation condition. In an embodiment, the processor 12 may adopt the whitelist filtering mechanism and/or the blacklist filtering mechanism according to requirements to determine whether the external device 100 meets the de-isolation condition, and the disclosure is not limited thereto.

In an embodiment, if the processor 12 determines that the external device 100 does not meet the de-isolation condition, the processor 12 may maintain the external device 100 in the isolation status (that is, not switching the external device 100 from the isolation status to the connection status). At the same time, in a time period of the external device 100 being in the isolation status, the processor 12 may perform the security analyzation on the external device 100 through the sandbox analyzation module 102. For example, the processor 12 may monitor the behavior of the external device 100 through the sandbox analyzation module 102 to determine whether there is a security risk in the external device 100. Then, the processor 12 may determine whether to switch the external device 100 from the isolation status to the connection status according to the execution result of the security analyzation. In an embodiment, the sandbox analyzation module 102 may monitor the behavior of the external device 100 and determine whether there is a security risk in the external device 100 through various common security analyzation technologies (such as malicious program detection technology). The related operation details may be set according to practical requirements, and the disclosure is not limited thereto.

In an embodiment, in a time period of the external device 100 being in the isolation status, if the processor 12 determines that there is a security risk (for example, the execution result of the security analyzation reflects that the external device 100 has a high probability of carrying malicious programs) in the external device 100 according to the execution result of the security analyzation, then the processor 12 may maintain the external device 100 in the isolation status (that is, not switching the external device 100 from the isolation status to the connection status). Thereby, it is effectively prevented from the electronic device 10 (or the kernel system 101) being infected by the malicious programs carried by the external device 100.

In an embodiment, in a time period of the external device 100 being in the isolation status, if the processor 12 determines that there is no (significant) security risk (for example, the execution result of the security analyzation reflects that the external device 100 has a high probability of not carrying malicious programs) in the external device 100 according to the execution result of the security analyzation, then the processor 12 may switch the external device 100 from the isolation status to the connection status. Thereafter, in the connection status, the kernel system 101 can access the external device 100. Thereby, the security of the electronic device 10 (or the kernel system 101) when accessing the external device 100 can be effectively enhanced under the premise of minimizing the impact on the working performance of the electronic device 10.

In an embodiment, in a time period of the external device 100 being in the isolation status, the processor 12 may associate the external device 100 with a specific container (also referred to as a first container). Then, in a time period of the external device 100 being in the isolation status, the sandbox analyzation module 102 may monitor the behavior of the external device 100 through the first container.

In an embodiment, the container type of the first container is a sandbox container. Therefore, the operational behavior of the external device 100 in the first container (that is, the sandbox container) does not affect the kernel system 101. Thereby, even if the external device 100 carries malicious programs, by running the external device 100 in the first container (that is, the sandbox container), it is prevented from the kernel system 101 being infected by the malicious programs carried by the external device 100.

In an embodiment, if the external device 100 is in the connection status, then the processor 12 may associate the external device 100 with another container (also referred to as a second container). It should be noted that, compared to the first container, the container type of the second container is a general container. Thereby, in a time period of the external device 100 being in the connection status, the kernel system 101 can access the external device 100 through the second container.

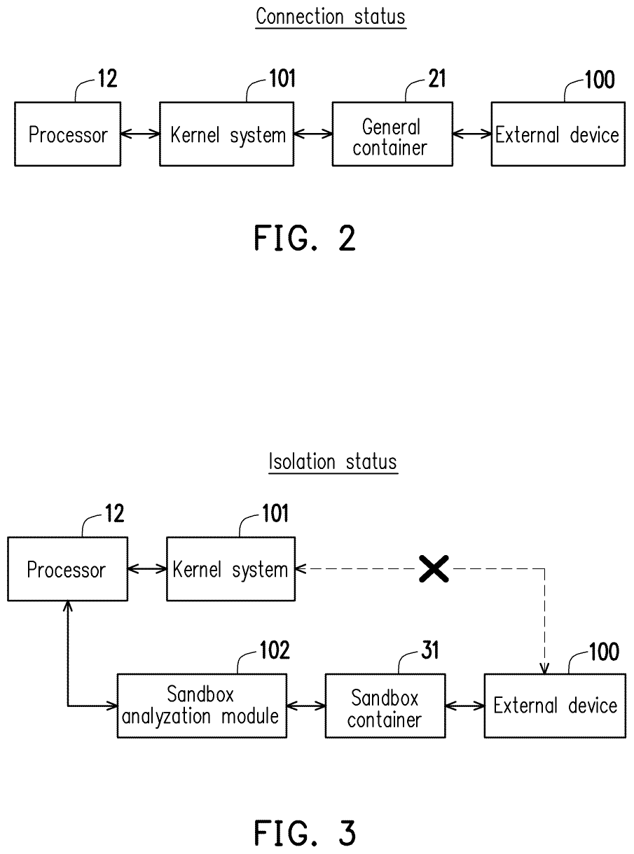

FIG. 2 is a schematic diagram of accessing an external device in a connection status according to an embodiment of the disclosure. Referring to FIG. 1 and FIG. 2, in an embodiment, it is assumed that the external device 100 is connected to the electronic device 10. After switching the external device 100 to the connection status (that is, the binding status), the processor 12 may associate the external device 100 with a container 21. For example, the container 21 is a general container. Thereafter, the kernel system 101 can access the external device 100 through the container 21. For example, the processor 12 may run the kernel system 101 and read data from the external device 100, store data to the external device 100 through the container 21, and/or execute specific operational behaviors through the external device 100.

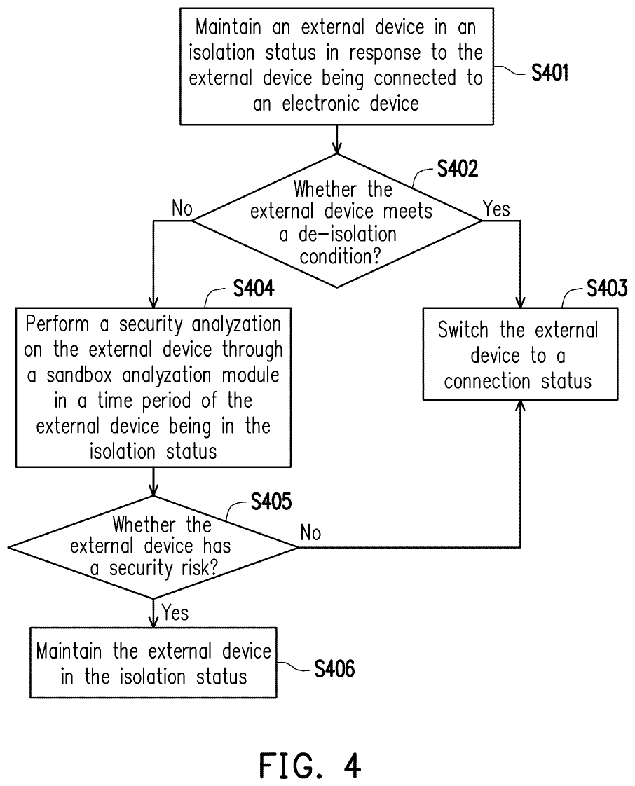

FIG. 3 is a schematic diagram of executing a security analyzation on the external device through a sandbox analyzation module in an isolation status according to an embodiment of the disclosure. Referring to FIG. 1 and FIG. 3, in an embodiment, it is assumed that the external device 100 is connected to the electronic device 10. In a time period of the external device 100 being in the isolation status (that is, the non-binding status), the processor 12 may associate the external device 100 with a container 31. For example, the container 31 is a sandbox container. Thereafter, the processor 12 may run the sandbox analyzation module 102 and execute the security analyzation on the external device 100 through the container 31. According to the execution result of the security analyzation, the processor 12 may determine to maintain the external device 100 in the isolation status or switch the external device 100 from the isolation status to the connection status. It should be noted that, in the time period of the external device 100 being in the isolation status (that is, the non-binding status), the processor 12 may prohibit the kernel system 101 from accessing the external device 100, so as to prevent from the kernel system 101 being infected by malicious programs that may be carried by the external device 100.

FIG. 4 is a flowchart of a device security analyzation method according to an embodiment of the disclosure. Referring to FIG. 4, in Step S401, in response to an external device being connected to an electronic device, the external device is maintained in an isolation status. In Step S402, it is determined whether the external device meets a de-isolation condition. If the external device meets the de-isolation condition, in Step S403, the external device is switched from the isolation status to the connection status.

However, if the external device does not meet the de-isolation condition, in Step S404, in a time period of the external device being in the isolation status, a security analyzation is performed on the external device through a sandbox analyzation module. In Step S405, it is determined whether the external device has a security risk according to an execution result of the security analyzation. If the external device has a security risk (for example, the external device has a relatively higher probability of carrying malicious programs), then in Step S406, the external device is maintained in the isolation status. Alternatively, if the external device does not have a security risk (for example, the external device has a relatively lower probability of carrying malicious programs), then the operation may proceed to Step S403, and the external device is switched from the isolation status to the connection status.

However, each step in FIG. 4 has been explained in detail as above, so details will not be repeated here. It is worth noting that each step in FIG. 4 may be implemented as multiple codes or circuits, and the disclosure is not limited thereto. In addition, the method of FIG. 4 may be used in conjunction with the above exemplary embodiments, or may be used independently, and the disclosure is not limited thereto.

In summary, the device security analyzation method and the electronic device proposed by the embodiments of the disclosure may, when initially connecting to an external device with unknown security, temporarily maintain the external device in the isolation status (that is, the non-binding status), so as to prevent from the kernel system of the electronic device being infected by malicious programs that may be carried by the external device. After confirming that the external device is trustworthy, the external device may be switched to the connection status (that is, the binding status), to facilitate the kernel system of the electronic device accessing the external device. Thereby, the security of the electronic device when accessing the external device can be effectively enhanced under the premise of minimizing the impact on the working performance of the electronic device.

Although the disclosure has been disclosed by the embodiments as above, the embodiments are not intended to limit the disclosure. Persons skilled in the art may make some changes and modifications without departing from the spirit and scope of the disclosure. Therefore, the protection scope of the disclosure should be defined by the appended claims.

What is claimed is:

1. A device security analyzation method for an electronic device, wherein the electronic device runs with a sandbox analyzation module, and the device security analyzation method comprises:
in response to an external device being connected to the electronic device, maintaining the external device in an isolation status, and determining whether the external device meets a de-isolation condition;
if the external device does not meet the de-isolation condition, in a time period of the external device being in the isolation status, performing a security analyzation on the external device through the sandbox analyzation module; and
determining whether to switch the external device to a connection status according to an execution result of the security analyzation.

2. The device security analyzation method as claimed in claim 1, wherein in the isolation status, a kernel system of the electronic device cannot access the external device.

3. The device security analyzation method as claimed in claim 1, wherein in the connection status, a kernel system of the electronic device can access the external device.

4. The device security analyzation method as claimed in claim 1, wherein determining whether the external device meets the de-isolation condition comprises:
obtaining device identification information of the external device;
comparing the device identification information with a device list; and
determining whether the external device meets the de-isolation condition according to a comparison result.

5. The device security analyzation method as claimed in claim 1, wherein in the time period of the external device being in the isolation status, performing the security analyzation on the external device through the sandbox analyzation module comprises:
in the time period of the external device being in the isolation status, associating the external device with a first container; and
monitoring, by the sandbox analyzation module, behavior of the external device through the first container,
wherein the behavior of the external device in the first container does not affect a kernel system of the electronic device.

6. The device security analyzation method as claimed in claim 1, further comprising:
if the external device meets the de-isolation condition, switching the external device to the connection status.

7. The device security analyzation method as claimed in claim 1, further comprising:
if the external device is in the connection status, associating the external device to a second container; and
accessing, by a kernel system of the electronic device, the external device through the second container.

8. An electronic device, comprising:
an interface circuit configured to connect to an external device;
a storage circuit configured to store a sandbox analyzation module; and
a processor connected to the interface circuit and the storage circuit,
wherein the processor is configured to:
in response to the external device being connected to the electronic device through the interface circuit, maintain the external device in an isolation status, and determine whether the external device meets a de-isolation condition;
if the external device does not meet the de-isolation condition, in a time period of the external device being in the isolation status, perform a security analyzation on the external device through the sandbox analyzation module; and
determine whether to switch the external device to a connection status according to an execution result of the security analyzation.

9. The electronic device as claimed in claim 8, wherein in the isolation status, a kernel system of the electronic device cannot access the external device.

10. The electronic device as claimed in claim 8, wherein in the connection status, a kernel system of the electronic device can access the external device.

11. The electronic device as claimed in claim 8, wherein an operation of the processor determining whether the external device meets the de-isolation condition comprises:
obtaining device identification information of the external device;
comparing the device identification information with a device list; and
determining whether the external device meets the de-isolation condition according to a comparison result.

12. The electronic device as claimed in claim 8, wherein in the time period of the external device being in the isolation status, an operation of the processor performing the security analyzation on the external device through the sandbox analyzation module comprises:
in the time period of the external device being in the isolation status, associating the external device with a first container; and
monitoring, by the sandbox analyzation module, behavior of the external device through the first container,
wherein the behavior of the external device in the first container does not affect a kernel system of the electronic device.

13. The electronic device as claimed in claim 8, wherein the processor is further configured to:
if the external device meets the de-isolation condition, switch the external device to the connection status.

14. The electronic device as claimed in claim 8, wherein the processor is further configured to:
if the external device is in the connection status, associate the external device to a second container; and
access, by a kernel system of the electronic device, the external device through the second container.
